(19) United States
(12) Patent Application Publication
(10) Pub. No.: US 2005/0119876 A1
(43) Pub. Date: Jun. 2, 2005

(54) Speech recognition method using a single transducer

(75) Inventors: Alexandre Ferrieux, Pleumeur Bodou (FR); Lionel Delphin-Poulat, Lannion (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: France Telecom SA

(21) Appl. No.: 10/509,082

(22) PCT Filed: Mar. 20, 2003
(86) PCT No.: PCT/FR03/00884

(30) Foreign Application Priority Data
Mar. 29, 2002 (FR) 0204286

(51) Int. Cl. G06F 17/21

(52) U.S. Cl. 704/10

(57) ABSTRACT

Input data are translated into a lexical output sequence. Sub-lexical entities and various possible combinations of the entities are identified as states ei and ej of first and second language models, respectively, intended to be stored, with an associated likelihood value and a table having memory areas. Each memory area is intended to contact at least one combination of the states and has an address equal to a value h [(ei:ej)] of a scalar function h applied to parameters peculiar to the combination (ei:ej). There is reduced complexity of accesses to information produced by a single transducer formed by a single Viterbi machine using the models.

The present invention concerns a method of translating input data into at least one lexical output sequence, including a step of decoding input data during which lexical entities which the said data represent are identified by means of at least one model.

Such methods are commonly used in speech recognition applications, where at least one model is used for recognising information present in the input data, an item of information being able to consist for example of a set of vectors of parameters of a continuous acoustic space, or a label allocated to a sub-lexical entity.

In certain applications, the term “lexical” will apply to a sentence considered as a whole, as a series of words, and the sub-lexical entities will then be words, whilst in other applications the term “lexical” will apply to a word, and the sub-lexical entities will then be phonemes or syllables able to form such words, if these are literal in nature, or figures, if the words are numerical in nature, that is to say numbers.

A first approach for carrying out speech recognition consists of using a particular type of model which has a regular topology and is intended to learn all the variant pronunciations of each lexical entity, that is to say for example a word, included in the model. According to this first approach, the parameters of a set of acoustic vectors peculiar to each item of information which is present in the input data and corresponds to an unknown word must be compared with sets of acoustic parameters each corresponding to one of the very many symbols contained in the model, in order to identify a modelled symbol to which this information most likely corresponds. Such an approach in theory guarantees a high degree of recognition if the model used is well designed, that is to say almost exhaustive, but such quasi-exhaustiveness can be obtained only at the cost of a long process of learning of the model, which must assimilate an enormous quantity of data representing all the variant pronunciations of each of the words included in this model. This learning is in fact carried out by having all the words in a given vocabulary pronounced by a large number of persons, and recording all the variant pronunciations of these words. It is clear that the construction of a quasi-exhaustive lexical model cannot in practice be envisaged for vocabularies having a size greater than a few hundreds of words.

A second approach has been designed for the purpose of reducing the learning time necessary for speech recognition applications, a reduction which is essential for translation applications on very large vocabularies which may contain several hundreds of thousands of words, the said second approach consisting of effecting a breakdown of the lexical entities by considering them as collections of sub-lexical entities, using a sub-lexical model modelling the said sub-lexical entities with a view to allowing their identification in the input data, and an articulation model modelling various possible combinations of these sub-lexical entities.

Such an approach, defined for example in Chapter 16 of the manual “Automatic Speech and Speaker Recognition”, published by Kluwer Academic Publishers, makes it possible to considerably reduce, compared with the model used in the context of the first approach described above, the individual durations of the learning processes of the sub-lexical model and of the articulation model, since each of these models has a simple structure compared with the lexical model used in the first approach.

The known methods of implementing this second approach usually have recourse to first and second transducers, each formed by a Markov model representing a certain knowledge source, that is to say, in order to take the case mentioned above, a first Markov model representing sub-lexical entities and a second Markov model representing possible combinations of the said sub-lexical entities. During a step of decoding input data, states contained in the first and second transducers, the said states respectively representing possible modellings of the sub-lexical entities to be identified and possible modellings of combinations of the said sub-lexical entities, will be activated. The activated states of the first and second transducers will then be stored in storage means.

According to one elegant conceptual representation of this second approach, the first and second transducers can be represented in the form of a single transducer equivalent to the first and second transducers taken in their composition, making it possible to translate the input data into lexical entities by simultaneously using the sub-lexical model and the articulation model.

According to this conceptual representation, the storage of the states activated during the decoding step is equivalent to a storage of states of this single transducer, each state of which can be considered to be a pair formed by a state of the first transducer formed by the first model constructed on the basis of sub-lexical entities on the one hand and a state of the second transducer formed by the second model constructed on the basis of lexical entities on the other hand. Such a storage could be made anarchically, as the states are produced. However, the maximum number of different states which the single transducer can take is very large, since it is equal to a product of the maximum number of states which each of the first and second transducers can take. Moreover, the number of states of the single transducer actually useful for decoding, that is to say actually corresponding to sub-lexical and lexical sequences enabled in the language in question, is relatively small compared with the maximum number of states possible, particularly if states whose activation is improbable, although theoretically enabled, are excluded by convention. Thus an anarchic storage of the states produced by the single transducer results in using a memory with a very large size, in which the information representing the states produced will be very scattered, which will result in using, for their addressing for purposes of reading or writing, numbers of large size requiring a memory access management system which is unduly complex compared with the volume of useful information actually contained in the memory, which will give rise to long memory access times incompatible with time constraints inherent for example in real-time translation applications.

The aim of the invention is to remedy this drawback to a great extent, by proposing a method of translating data using a single transducer and storage means intended to contain information relating to the activated states of the said single transducer, a method by virtue of which accesses to the said information in read/write mode can be executed sufficiently rapidly to allow use of the said method in real-time translation applications.

This is because, according to the invention, a method of translating input data into at least one lexical output sequence includes a step of decoding the input data during which sub-lexical entities represented by the said data are identified by means of a first model constructed on the basis of predetermined sub-lexical entities, and during which there are generated, as the sub-lexical entities are identified and with reference to at least one second model constructed on the basis of lexical entities, various possible combinations of the said sub-lexical entities, each combination being intended to be stored, conjointly with an associated likelihood value, in storage means which include a plurality of memory areas, each of which is able to contain at least one of the said combinations, each area being provided with an address equal to a value taken by a predetermined scalar function when the said function is applied to parameters peculiar to sub-lexical entities and to their combination intended to be stored together in the area in question.

The use of memory areas addressed by means of a predetermined scalar function makes it possible to organise the storage of the useful information produced by this single transducer and to simplify the management of the accesses to this information since, in accordance with the invention, the memory is subdivided into areas each intended to contain information relating to states actually produced by the single transducer. This allows addressing of the said areas by means of a number whose size is reduced compared with the size necessary for the addressing of a memory designed to store anarchically any pair of states of the first and second transducers.

In one advantageous implementation of the invention, an essentially injective function will be chosen for the predetermined scalar function, that is to say a function which, applied to various parameters, will without exception take different values, which ensures that each memory area will in principle contain only information relating to at most one combination of sub-lexical entities, that is to say a single state of the equivalent transducer, which further simplifies the accesses to the said information by eliminating the need for sorting, within a same memory area, between information relating to various combinations of sub-lexical entities.

In a variant of this implementation, the predetermined scalar function will also essentially be surjective in addition to being injective, that is to say each memory area available is intended to actually contain, unless there is an exception, information relating to a single combination of sub-lexical entities, which represents optimum use of the storage means since their storage potential will then be fully exploited. In this variant, the predetermined scalar function will in fact be essentially bijective, as both essentially injective and subjective.

The parameters of the predetermined scalar function can take many forms according to the chosen implementation of the invention. In one of these implementations, the sub-lexical model contains models of sub-lexical entities, the different states of which are numbered contiguously and have a total number less than or equal to a first predetermined number peculiar to the sub-lexical model, and the articulation model contains models of possible combinations of sub-lexical entities, various states of which are numbered contiguously and have a total number less than or equal to a second predetermined number peculiar to the articulation model, the numbers of the states of the sub-lexical entities and the possible combinations thereof constituting the parameters to which the predetermined scalar function is intended to be applied.

The predetermined scalar function can take many forms according to the chosen implementation of the invention. In a particular implementation of the invention, each value taken by the predetermined scalar function is a concatenation of a remainder of a first integer division by the first predetermined number of the number of a state of a sub-lexical entity identified by means of the first model and a remainder of a second integer division by the second predetermined number of the number of a state of a combination identified by means of the second model.

Such a concatenation in principle guarantees that the values of the remainders of the first and second integer divisions will be used without alteration for the purpose of the addressing of the memory areas, thus giving rise to a maximum reduction in a risk of error in the addressing.

In a particularly advantageous embodiment of the invention, in that it uses tested means individually known to persons skilled in the art, the decoding step uses a Viterbi algorithm applied conjointly to a first Markov model having states representing various possible modellings of each sub-lexical entity enabled in a given translation language, and a second Markov model having states representing various possible modellings of each articulation between two sub-lexical entities enabled in the said translation language.

In a general aspect, the invention also concerns a method of translating input data into a lexical output sequence, including a step of decoding the input data intended to be executed by means of an algorithm of the Viterbi algorithm type, simultaneously using a plurality of distinct knowledge sources forming a single transducer whose states are intended to be stored, conjointly with an associated likelihood value, in storage means which include a plurality of memory areas, each of which is able to contain at least one of the said states, each area being provided with an address equipped with a value taken by a predetermined scalar function where the said function is applied to parameters peculiar to the states of the said single transducer.

The invention also concerns a system of recognising acoustic signals using a method as described above.

The characteristics of the invention mentioned above, as well as others, will emerge more clearly from a reading of the following description of an example embodiment, the said description being made in relation to the accompanying drawings, amongst which:

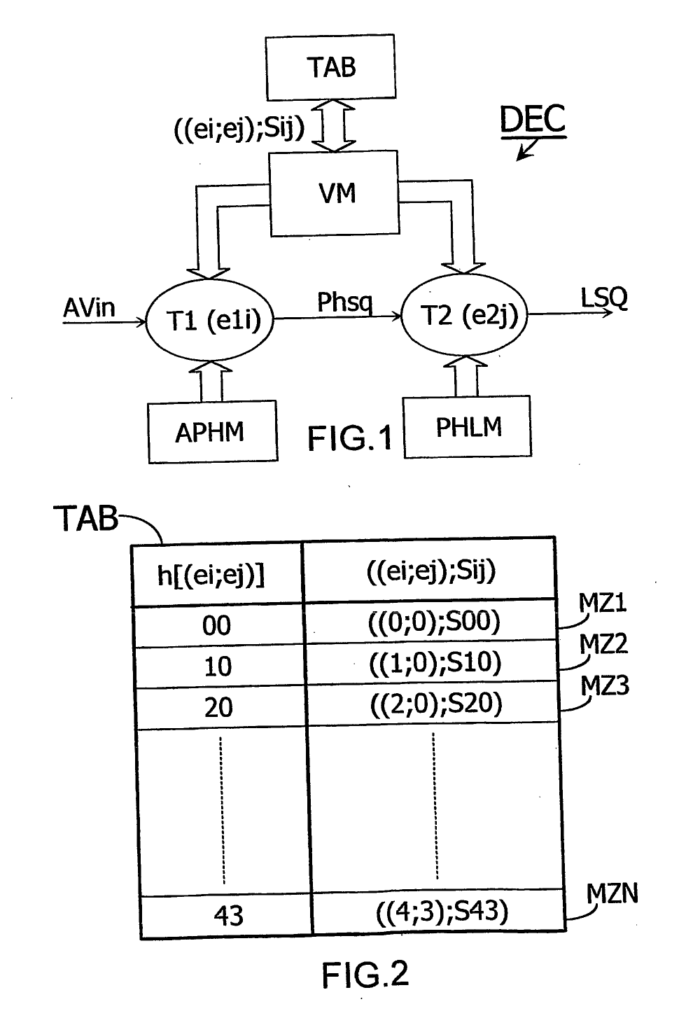

FIG. 1 is a conceptual diagram describing a decoder in which a method according to the invention is implemented,

FIG. 2 is a diagram describing the organisation of a table intended to store information produced by such a decoder,

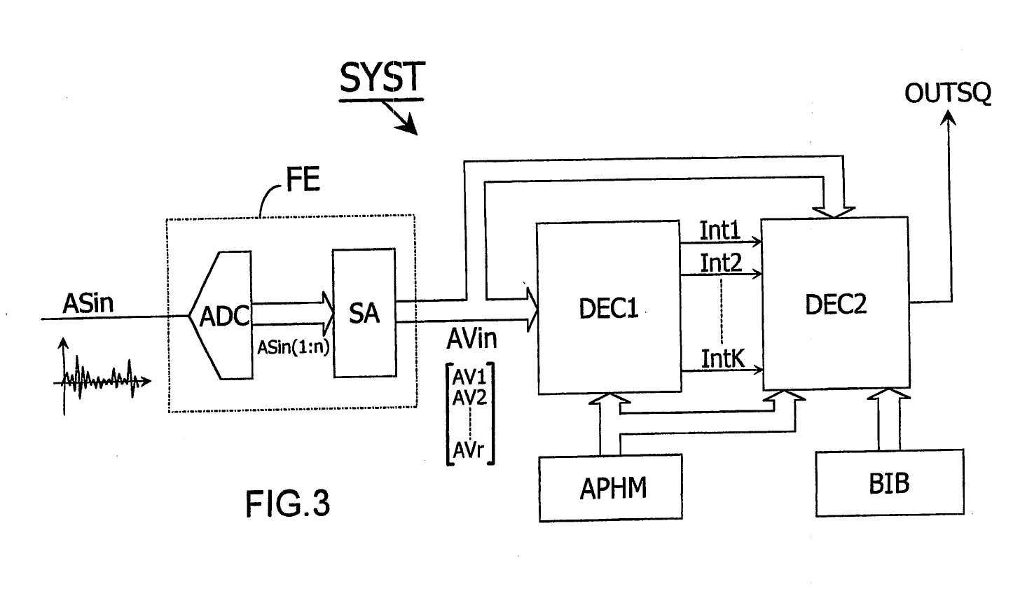

FIG. 3 is a functional diagram describing an acoustic recognition system in accordance with a particular embodiment of the invention,

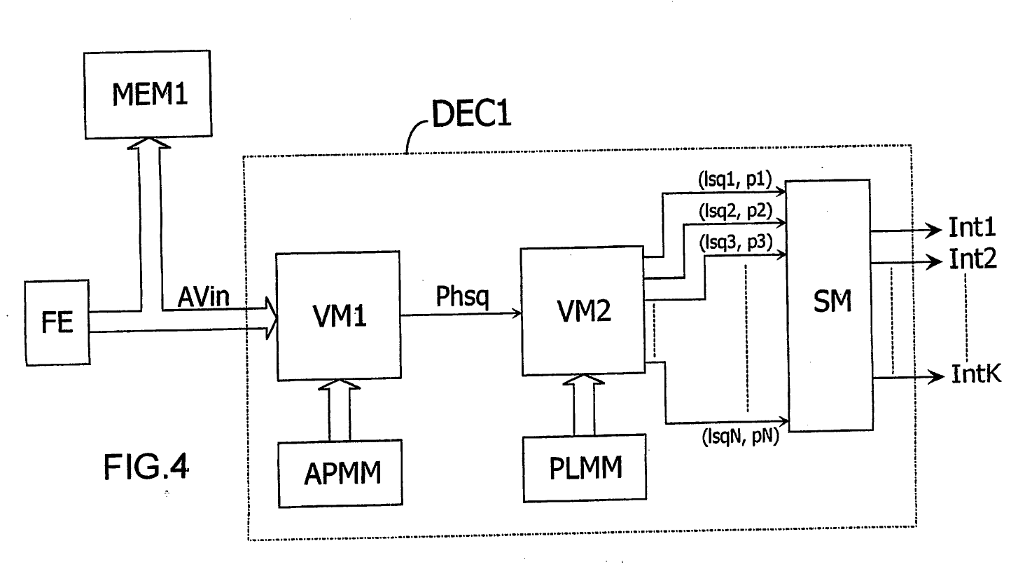

FIG. 4 is a functional diagram describing a first decoder intended to execute a first decoding step within this system, and

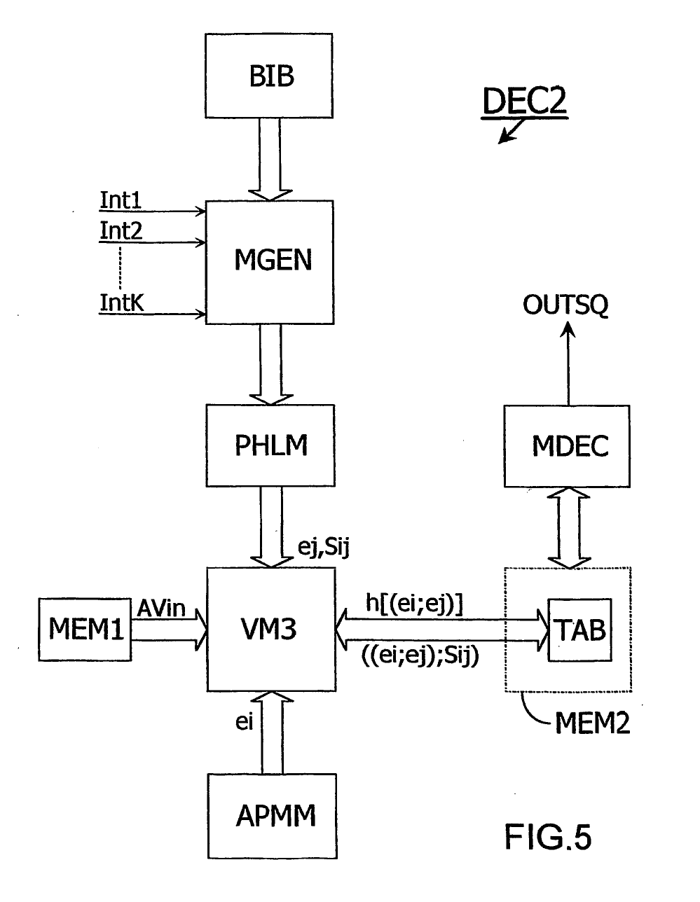

FIG. 5 is a functional diagram describing a second decoder intended to execute a second decoding step within this system in accordance with the method according to the invention.

FIG. 1 depicts a decoder DEC intended to receive input data AVin and to deliver a lexical output sequence LSQ. This decoder DEC includes a Viterbi machine VM intended to execute a Viterbi algorithm known to persons skilled in the art, the said Viterbi machine VM conjointly using a first Markov model APHM representing all the possible modellings of each sub-lexical entity enabled in a given translation language, and a second Markov model PHLM representing all the possible modellings of each articulation between two enabled sub-lexical entities in the said translation language, the said first and second Markov models APHM and PHLM being able to be respectively represented in the form of a first transducer T1 intended to convert sequences of acoustic vectors into sequences of sub-lexical entities Phsq, for example phonemes, and in the form of a second transducer T2 intended to convert the sequences of sub-lexical entities Phsq into lexical sequences LSQ, that is to say in this example into sequences of words. Each transducer T1 or T2 can be assimilated to an enhanced finite-state automatic controller, each state ei or ej corresponding respectively to a state of a sub-lexical entity or to a state of a combination of such entities identified by the first or second transducer T1 or T2. In such a conceptual representation, the decoder DEC is therefore a single transducer, equivalent to a composition of the first and second transducers T1 and T2, which simultaneously uses the sub-lexical model and the articulation model and produces states (ei; ej) each of which is a pair formed by a state ei of the first transducer T1 on the one hand and by a state ej of the second transducer T2 on the other hand, a state (ei; ej) itself representing a possible combination of sub-lexical entities. In accordance with the invention, each state (ei; ej) is intended to be stored, conjointly with an associated likelihood value Sij, in storage means, consisting in this example of a table TAB.

FIG. 2 depicts schematically a table TAB, which includes a plurality of memory areas MZ1, MZ2, MZ3 . . . MZN, each of which is able to contain at least one of the said states (e1i; e2j) of the single transducer, accompanied by the likelihood value Sij allocated to it. Each area MZ1, MZ2, MZ3 . . . MZN is provided with an address equal to a value taken by a predetermined scalar function h when the said function is applied to parameters peculiar to sub-lexical entities and to their combination intended to be stored in the area in question.

In the implementation of the invention described here, the scalar function h is an essentially injective function, that is to say a function which, applied to various parameters, will unless there is an exception take different values, which makes it possible to ensure that each memory area MZm (for m=1 to N) will in principle contain only information relating to at most a single combination of sub-lexical entities, that is to say to a single state (ei; ej) of the transducer formed by the decoder described above. The scalar function h is also essentially subjective in this example, that is to say each memory area MZm (for m=1 to N) is intended to actually contain, unless there is an exception, information relating to a state (ei; ej) of the said transducer. The scalar function h is therefore here essentially bijective, as both essentially injective and essentially surjective. When the transducer produces a new state (ex; ey), it will suffice, in order to know whether this composition of states of the first and second transducers has already been produced, and with what likelihood, to interrogate the table TAB by means of the address h[(ex; ey)]. If this address corresponds to a memory area MZm already defined in the table for a state (ei; ej), identity between the new state (ex; ey) and the state (ei; ej) already stored will be established.

In this embodiment, the sub-lexical model contains various possible modellings ei of each sub-lexical entity, numbered contiguously and having a total number less than or equal to a first predetermined number V1 peculiar to the sub-lexical model, and the articulation model contains various possible modellings ej and possible combinations of these sub-lexical entities, numbered contiguously and having a total number less than or equal to a second predetermined number V2 peculiar to the articulation model, the numbers of the sub-lexical entities and their possible combinations constituting the parameters to which the predetermined scalar function h is intended to be applied.

Each value taken by the predetermined scalar function is a concatenation of a remainder, which may vary from 0 to (V1-1), of a first integer division by the first predetermined number V1 of the number of the modelling of a state of a sub-lexical entity identified by means of the first model and a remainder, which may vary from 0 to (V2-1), of a second integer division by the second predetermined number V2 of the number of the modelling of a state of a combination of sub-lexical entities identified by means of the second model. Thus, if in one example, unrealistic since it is simplified to the extreme to afford easy understanding of the invention, the sub-lexical entities modelled in the first Markov model are three phonemes “p”, “a” and “o”, each of which can be modelled by five distinct states, that is to say states (ei=0, 1, 2, 3 or 4) for the phoneme “p”, states (ei=5, 6, 7, 8 or 9) for the phoneme “a”, and states (ei=10, 11, 12, 13 or 14) for the phoneme “o”, the first predetermined number V1 will be equal to 5.

If the combinations of sub-lexical entities modelled in the second Markov model are two combinations “pa” and “po” each of which can be modelled by two distinct states, that is to say states (ej=0 or 1) for the combination “pa” and states (ej=2 or 3) for the combination “po”, the second predetermined number will be equal to 4.

The various possible modellings of the sub-lexical entities and their combinations are N=20 in number at a maximum, the address h[(0; 0)] of the first memory area MZ1 will have as its value the concatenation of the remainder of the integer division 0/V1=0 with the remainder of the integer division 0/V2=0, that is to say the concatenation 00 of a value 0 with a value 0. The address h[(14; 3)] of the N^{th} memory area MZN will have as its value the concatenation of the remainder of the integer division of 14 by V1 (with V1=5) with the remainder of the integer division of 3 by V2 (with V2=4), that is to say the concatenation 43 of a value 4 with a value 3.

Such a concatenation in principle guarantees that the values of the remainders of the first and second integer divisions will be used without alteration for the purpose of addressing the memory areas, thus giving rise to a maximum reduction in a risk of error in the addressing. However, such a concatenation results in using numbers made artificially greater than necessary compared with the number of memory areas N actually addressed. Techniques, known to persons skilled in the art, make it possible to compress numbers to be concatenated by limiting the losses of information related to such a compression. It is possible for example to make provision for making binary representations of the said numbers overlap, by performing an exclusive-OR operation between least significant bits of one of these binary numbers with the most significant bits of the other binary number.

In order to facilitate understanding thereof, the above description of the invention has been given in an example of an application where a Viterbi machine operates on a single transducer formed by a composition of two Markov models. This description can be extended to applications where a single Viterbi machine simultaneously uses a number P greater than 2 of different knowledge sources, thus forming a single transducer intended to produce states (e1i; e2j; . . . ; ePs), each of which being able to be stored in a memory area of a table, which memory area will be identified by means of an address h[(e1i; e2j; . . . ; ePs)] where h is a predetermined scalar function as described above.

FIG. 3 depicts schematically an acoustic recognition system SYST according to a particular embodiment of the invention, intended to translate an input acoustic signal ASin into a lexical output signal OUTSQ. In this example, the input signal ASin consists of an analogue electronic signal which may come for example from a microphone, not shown in the figure. In the embodiment described here, the system SYST includes an input stage FE, containing an analogue to digital conversion device ADC intended to supply a digital signal ASin(1:n), formed from samples ASin(1), ASin(2) . . . ASin(n) each coded in b bits, and representing the acoustic input signal ASin, and a sampling module SA intended to convert the digitised acoustic signal ASin(1:n) into a sequence of acoustic vectors AVin, each vector being provided with components AV1, AV2 . . . AVr, where r is the dimension of an acoustic space defined for a given application for which the translation system SYST is intended, each of the components AVi (for i=1 to r) being evaluated as a function of characteristics peculiar to this acoustic space. In other embodiments of the invention, the input signal ASin can, from the outset, be of a digital nature, which will make it possible to dispense with the presence of the analogue to digital conversion device ADC within the input stage FE.

The system SYST also includes a first decoder DEC1 intended to supply a selection Int1, Int2 . . . IntK of possible interpretations of the sequence of acoustic vectors AVin with reference to a model APHM constructed on the basis of predetermined sub-lexical entities.

The system SYST also includes a second decoder DEC2 in which a translation method according to the invention is implemented with a view to analysing input data consisting of the acoustic vectors AVin with reference to a first model constructed on the basis of predetermined sub-lexical entities, for example extracted from the model APHM, and with reference to a second model constructed on the basis of acoustic modellings coming from a library BIB. The second decoder DEC2 will thus identify those of the said interpretations Int1, Int2 . . . IntK which are to constitute the lexical output sequence OUTSQ.

FIG. 4 depicts in more detail the first decoder DEC1, which includes a first Viterbi machine VM1 intended to execute a first sub-step of decoding the sequence of acoustic vectors AVin representing the acoustic input signal and previously generated by the input stage FE, which sequence will in addition advantageously be stored in a storage unit MEM1 for reasons which will emerge later in the disclosure. The first decoding sub-step is carried out with reference to a Markov model APMM enabling in a loop all the sub-lexical entities, preferably all the phonemes of the language into which the acoustic input signal is to be translated if it is considered that the lexical entities are words, the sub-lexical entities being represented in the form of predetermined acoustic vectors.

The first Viterbi machine VM1 is able to restore a sequence of phonemes Phsq which constitutes the closest phonetic translation of the sequence of acoustic vectors AVin. The subsequent processings carried out by the first decoder DEC1 will thus be done at the phonetic level, rather than at the vector level, which considerably reduces the complexity of the said processings, each vector being a multidimensional entity having r components, whilst a phoneme may in principle be identified by a unidimensional label which is peculiar to it, such as for example a label “OU” allocated to an oral vowel “u”, a label “CH” allocated to an unvoiced fricative consonant “∫”. The sequence of phonemes Phsq generated by the first Viterbi machine VM1 thus consists of a succession of labels more easily manipulatable than acoustic vectors would be.

The first decoder DEC1 includes a second Viterbi machine VM2 intended to execute a second sub-step of decoding the sequence of phonemes Phsq generated by the first Viterbi machine VM1. This second decoding step is carried out with reference to a Markov model PLMM consisting of sub-lexical transcriptions of lexical entities, that is to say in this example phonetic transcriptions of words present in the vocabulary of the language into which the acoustic input signal is to be translated. The second Viterbi machine is intended to interpret the sequence of phonemes Phsq, which is very noisy because the model APMM used by the first Viterbi machine VM1 is of great simplicity, and uses predictions and comparisons between series of labels of phonemes contained in the sequence of phonemes Phsq and various possible combinations of labels of phonemes provided for in the Markov model PLMM. Although a Viterbi machine normally restores only the sequence which has the greatest probability, the second Viterbi machine VM2 used here will advantageously restore all the sequences of phonemes 1sq1, 1sq2 . . . 1sqN that the said second machine VM2 has been able to reconstitute, with associated probability values p1, p2 . . . pN which will have been calculated for the said sequences and will represent the reliability of the interpretations of the acoustic signal that these sequences represent.

All the possible interpretations 1sq1, 1sq2 . . . 1sqN being automatically made available at the end of the second decoding substep, a selection made by a selection module SM of the K interpretations Int1, Int2 . . . IntK which have the highest probability values is easy whatever the value of K which has been chosen.

The Markov models APMM and PLMM can be considered to be subsets of the model APHM mentioned above.

The first and second Viterbi machines VM1 and VM2 can function in parallel, the first Viterbi machine VM1 then gradually generating labels of phonemes which will immediately be taken into account by the second Viterbi machine VM2, which makes it possible to reduce the total delay perceived by a user of the system necessary for combining the first and second decoding substeps by enabling the use of all the calculation resources necessary for the functioning of the first decoder DEC1 as soon as the acoustic vectors AVin representing the input acoustic signal appear, rather than after they have been entirely translated into a complete sequence of phonemes Phsq by the first Viterbi machine VM1.

FIG. 5 depicts in more detail a second decoder DEC2 in accordance with a particular embodiment of the invention. This second decoder DEC2 includes a third Viterbi machine VM3 intended to analyse the sequence of acoustic vectors AVin representing the acoustic input signal which was previously stored for this purpose in the storage unit MEM1.

To this end, the third Viterbi machine VM3 is intended to identify the sub-lexical entities whose acoustic vectors AVin are representative by means of a first model constructed on the basis of predetermined sub-lexical entities, in this example the Markov model APMM used in the first decoder and already described above, and to produce states e1i representing the sub-lexical entities thus identified. Such a use of the Markov model APMM can be represented as an implementation of a first transducer T1 similar to that described above.

The third Viterbi machine VM3 also generates, as the sub-lexical entities are identified and with reference to at least one specific Markov model PHLM constructed on the basis of lexical entities, various possible combinations of the sub-lexical entities, and produces states e2j representing combinations of the sub-lexical entities thus generated, the most likely combination being intended to form the lexical output signal OUTSQ. Such a use of the Markov model PHLM can be represented as a use of a second transducer T2 similar to that described above.

The simultaneous use of the Markov models APMM and PHLM by the third Viterbi machine VM3 can therefore be apprehended as the use of a single transducer formed by a composition of the first and second transducers such as those described above, intended to produce states (ei; ej) each provided with a likelihood value Sij. In accordance with the above description of the invention, these states will be stored in a table TAB included in a storage unit MEM2, which can form part of a central memory or of a cache memory also including the storage unit MEM1, each state (ei; ej) being stored with its associated likelihood value Sij in a memory area having as its address a value h[(ei; ej)], with the advantages in terms of speed of access previously mentioned. A memory decoder MDEC will select, at the end of the decoding process, the combination of sub-lexical entities stored in the table TAB which has the greatest likelihood, that is to say largest value of Sij, intended to form the lexical output sequence OUTSQ.

The specific Markov model PHLM is here specifically generated by a model creation module MGEN and solely represents possible collections of phonemes within sequences of words formed by the various phonetic interpretations Int1, Int2 . . . IntK of the acoustic input signal which were delivered by the first decoder, the said collections being represented by acoustic models coming from a library BIB of the lexical entities which correspond to these interpretations. The specific Markov model PHLM therefore has a restricted size because of its specific nature.

In this way, accesses to the storage units MEM1 and MEM2 as well as to the various Markov models used in the example embodiment of the invention described above require management of low complexity, because of the simplicity of the structure of the said models and of the system of addressing the information intended to be stored and read in the said storage units. These memory accesses can therefore be executed sufficiently rapidly to make the system described in this example able to perform translations in real time of input data in lexical output sequences.

Although the invention has been described here in the context of an application within a system including two decoders disposed in cascade, it can be entirely envisaged, in other embodiments of the invention, using only a single decoder similar to the second decoder described above, which may for example perform an acoustico-phonetic analysis and store, as the phonemes are identified, various possible combinations of the said phonemes, the most likely combination of phonemes being intended to form the lexical output sequence.

1-8. (canceled)

9. Method of translating input data into at least one lexical output sequence including a step of decoding the input data so (a) sub-lexical entities represented by the said data are identified by using a first model determined by predetermined sub-lexical entities, and (b) various possible combinations of the sub-lexical entities are generated, as the sub-lexical entities are identified and with reference to at least one second model constructed on the basis of lexical entities, each combination being intended to be stored, conjointly with an associated likelihood value, in a storage arrangement having plural memory areas able to store at least one of the said combinations, each area having an address equal to a value taken by a predetermined scalar function as a result of said function being applied to parameters peculiar to sub-lexical entities and to their combination intended to be stored together in the area in question.

10. Translation method according to claim 9, in which the predetermined scalar function is of an injective nature.

11. Translation method according to claim 10, in which the predetermined scalar function is also of a surjective nature.

12. Translation method according to claim 11, in which the sub-lexical model includes models of sub-lexical entities, different states of which are numbered contiguously and have a total number less than or equal to a first predetermined number peculiar to the sub-lexical model, and in which the articulation model includes models of possible combinations of sub lexical entities, different states of which are numbered contiguously and have a total number less than or equal to a second predetermined number peculiar to the articulation model, the numbers of the states of the sub-lexical entities and their possible combinations being the parameters to which the predetermined scalar function is intended to be applied.

13. Translation method according to claim 12, in which each value taken by the predetermined scalar function is a concatenation of the remainder of a first integer division by the first predetermined number of the number of a state of a sub-lexical entity identified by the first model and a remainder of the second integer division by the second predetermined number of the number of a state of a combination identified by the second model.

14. Translation method according to claim 13, wherein the decoding step uses a Viterbi algorithm applied conjointly with a first Markov model having states representing various possible modellings of each sub-lexical entity enabled in a given translation language, and to a second Markov model having states representing various possible modellings of each articulation between two sub-lexical entities enabled in the said translation language.

15. Translation method according to claim 9, wherein the decoding step uses a Viterbi algorithm applied conjointly with a first Markov model having states representing various possible modellings of each sub-lexical entity enabled in a given translation language, and to a second Markov model having states representing various possible modellings of each articulation between two sub-lexical entities enabled in the said translation language.

16. Speech recognition system for performing a translation method according to claim 9.

17. Speech recognition system for performing a translation method according to claim 10.

18. Speech recognition system for performing a translation method according to claim 11.

19. Speech recognition system for performing a translation method according to claim 12.

20. Speech recognition system for performing a translation method according to claim 13.

21. Speech recognition system for performing a translation method according to claim 14.

22. Speech recognition system for performing a translation method according to claim 15.

23. Method of translating input data into a lexical output sequence, including a step of decoding the input data intended to be executed by a Viterbi algorithm, simultaneously using a plurality of distinct knowledge sources forming a single transducer whose states are intended to be stored conjointly with an associated likelihood value, in a storage arrangement having memory areas, each of the memory areas being able to store at least one the said states, each area having an address equal to a value taken by a predetermined scalar function as a result of said function being applied to parameters peculiar to the states of said single transducer.

24. Speech recognition system for performing a translation method according to claim 23.

25. The method of claim 23 further including storing the states of the single transducer conjointly with the associated likelihood value in the storage arrangement having the memory areas.

26. Method of translating input data into at least one lexical output sequence including the steps of decoding the input data so (a) sub-lexical entities represented by the said data are identified by using a first model determined by predetermined sub-lexical entities, and (b) various possible combinations of the sub-lexical entities are generated, as the sub-lexical entities are identified and with reference to at least one second model constructed on the basis of lexical entities: storing each combination conjointly with an associated likelihood value, in a storage arrangement having plural memory areas able to store at least one of the said combinations, each area having an address equal to a value taken by a predetermined scalar function as a result of said function being applied to parameters peculiar to sub-lexical entities and to their combination that is conjointly stored in the area.
